(19) United States
(12) Patent Application Publication
(10) Pub. No.: US 2002/0100142 A1
(43) Pub. Date: Aug. 1, 2002

(54) Clamping structure for foldable apparatus

(76) Inventor: Winky Lin, Taipei (TW)

Correspondence Address: Rosenberg, Klein & Lee, Suite 101, 3458 Ellicott Center Drive, Ellicott City, MD, 21043, US

(21) Appl. No.: 09/769,411

(22) Filed: Jan. 26, 2001

(51) Int. Cl. E05F 1/08

(52) U.S. Cl. 16/287

(57) ABSTRACT

A clamping structure for foldable apparatus comprises an arc-shaped elastic wire; and two linear elastic wires bent vertically from two ends of the arc-shaped elastic wire. The two linear elastic wires are pivotally arranged within two rounded holes formed on the two separated main bodies of the foldable apparatus, respectively. Each rounded hole has a distance with the pivotal shaft such that the clamping structure provides a torque to the separated main bodies of the foldable apparatus. Therefore, the foldable apparatus can be unfolded to 0° and 180°.

### FIELD OF THE INVENTION

The present invention relates to a clamping structure for foldable apparatus, especially relates to a clamping structure, which is arranged on the pivotal shaft of the foldable apparatus and uses an elastic wire to clamp the foldable apparatus when the foldable apparatus is folded or unfolded.

### BACKGROUND OF THE INVENTION

The etui or glass piece box generally has a foldable apparatus for accommodating a stored article. As shown in FIG. 1, the conventional foldable apparatus 1a has two shells 10a and 11a, and a pivotal shaft 12a pivotally connecting the two shells 10a and 11a. The foldable apparatus 1a is folded and unfolded through the pivotal shaft 12a. However, if the foldable apparatus 1a has not clamping device for restrict its unfolding angle and is excessively unfolded, the stored article may be dropped off or the pivotal shaft 12a may be broken due to mechanical fatigue. To overcome this problem, a clamping device 13a is provided on the pivotal shaft 12a, as shown in FIGS. 2 and 2A. As shown in those figures, the clamping device 13a is an arc-shaped elastic body with two end portions abutting the lateral fringes of the shells 10a and 11a. The provision of the clamping device 13a restricts the unfolding angle of the foldable apparatus 1a to, for example, 120°. If the unfolding angle of the foldable apparatus 1a exceeds 120°, the clamping device 13a may be detached from the foldable apparatus 1a. Therefore, this kind of foldable apparatus 1a cannot be applied to fold-type keyboard, which need 180° unfolding angle.

### SUMMARY OF THE INVENTION

It is the object of the present invention to provide a clamping structure for foldable apparatus such as fold-type keyboard such that fold-type keyboard can be unfolded to 180° unfolding angle with firm clamping.

To achieve the above object, the preset invention provides a clamping structure for foldable apparatus, which comprises an arc-shaped elastic wire; and two linear elastic wires bent vertically from two ends of the arc-shaped elastic wire. The two linear elastic wires are pivotally arranged within two rounded holes formed on the two separated main bodies of the foldable apparatus, respectively. Each rounded hole has a distance with the pivotal shaft such that the clamping structure provides a torque to the separated main bodies of the foldable apparatus. Therefore, the foldable apparatus can be unfolded to specific angles.

The various objects and advantages of the present invention will be more readily understood from the following detailed description when read in conjunction with the appended drawing, in which:

### BRIEF DESCRIPTION OF DRAWING

FIG. 1 shows the perspective view of a prior art foldable apparatus;

FIG. 2 shows the perspective view of another prior art foldable apparatus;

FIG. 2A shows the perspective view of the clamping device of prior art foldable apparatus;

FIG. 3 shows the perspective view of the clamping structure of the first preferred embodiment of the present invention;

FIG. 4 is a sectional view of the present invention in folding state;

FIG. 5 is a sectional view of the present invention in unfolding state;

FIG. 6A shows the perspective view of the clamping structure of the second preferred embodiment of the present invention;

FIG. 6B shows the perspective view of the clamping structure of the third preferred embodiment of the present invention;

FIG. 6C shows the perspective view of the clamping structure of the fourth preferred embodiment of the present invention;

FIG. 6D shows the perspective view of the clamping structure of the fifth preferred embodiment of the present invention; and

FIG. 6E shows the perspective view of the clamping structure of the sixth preferred embodiment of the present invention.

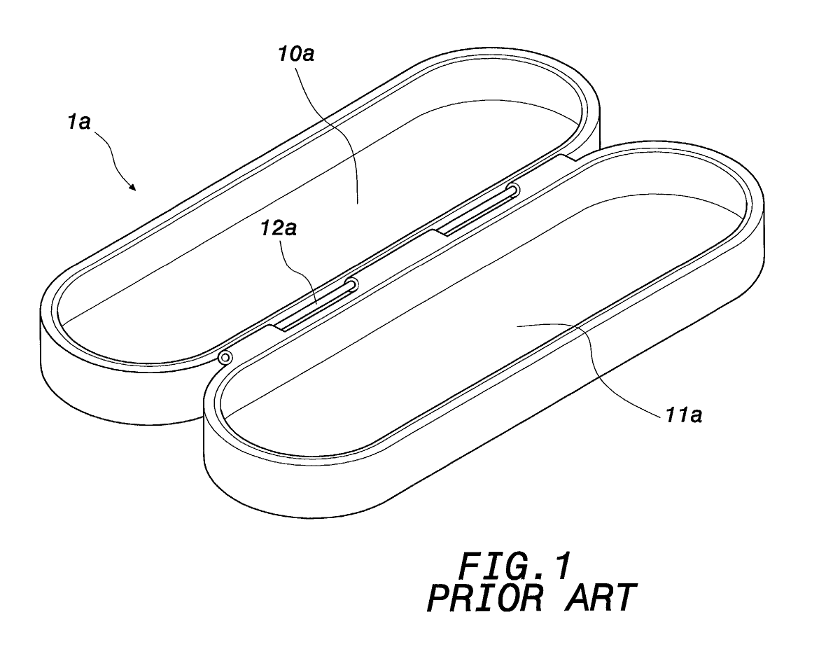

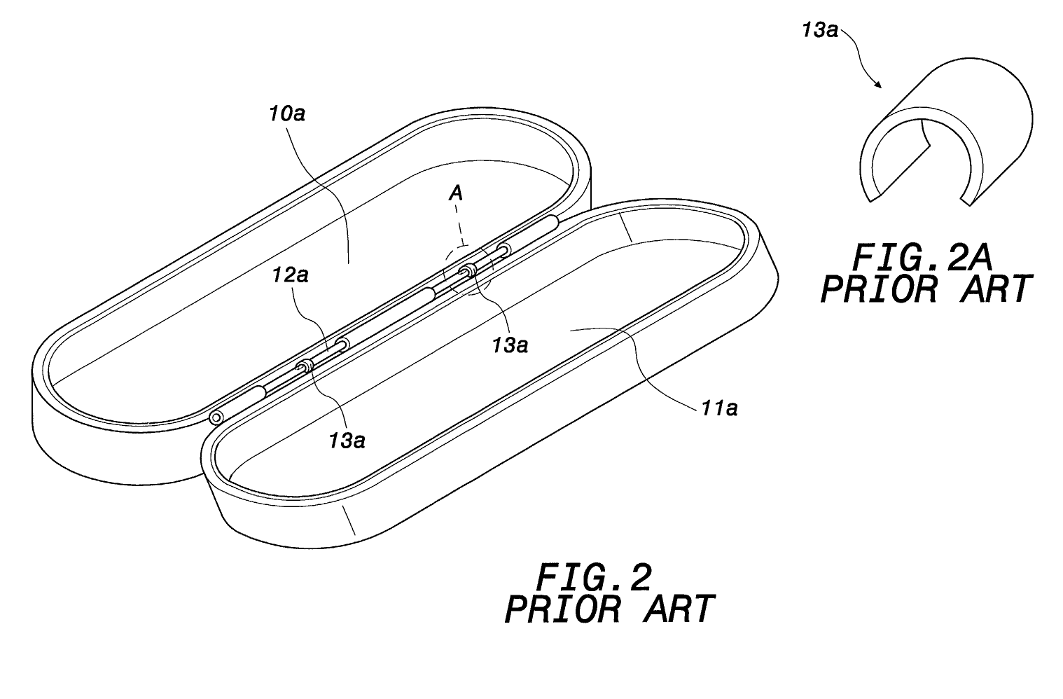

### DETAILED DESCRIPTION OF THE INVENTION

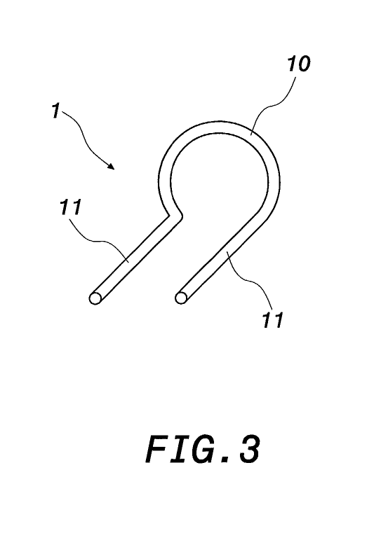

With reference now to FIG. 3, the clamping structure 1 for foldable apparatus according to the present invention comprises an arc-shaped elastic wire 10 and two linear elastic wires 11. The two linear elastic wires 11 are bent vertically from two ends of the arc-shaped elastic wire 10 and along the axis of the arc-shaped elastic wire 10, and parallel to each other.

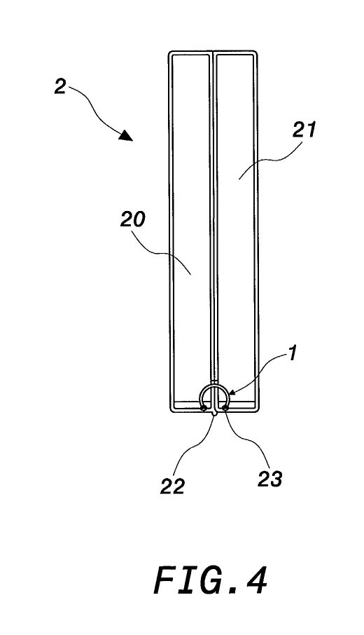

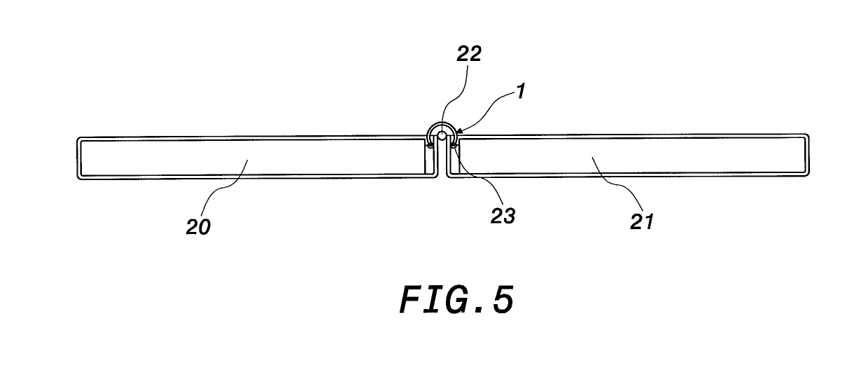

With reference now to FIGS. 4 and 5, in the preferred embodiment of the present invention, the foldable apparatus is a fold-type keyboard 2 with two separated main bodies 20 and 21. The two separated main bodies 20 and 21 are pivotally connected by a pivotal shaft 22, and folded or unfolded through the pivotal shaft 22. The two main bodies 20 and 21 each has a rounded hole 23 near the pivotal shaft 22. The two linear elastic wires 11 are arranged in the two rounded holes 23, and the arc-shaped elastic wire 10 is centered at the pivotal shaft 22. Moreover, the two rounded holes 23 are separated with the pivotal shaft 22 by a distance such that the clamping structure 1 provides a torque on the two main bodies 20 and 21. The fold-type keyboard 2 is subjected to the torque and clamped to 0° or 180° or other specific angles when being folded or unfolded.

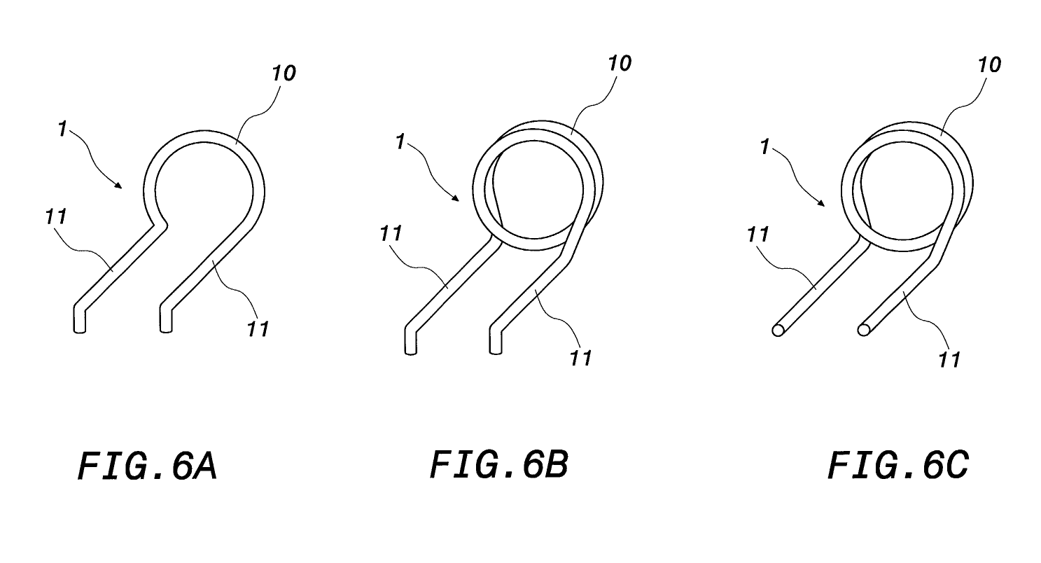

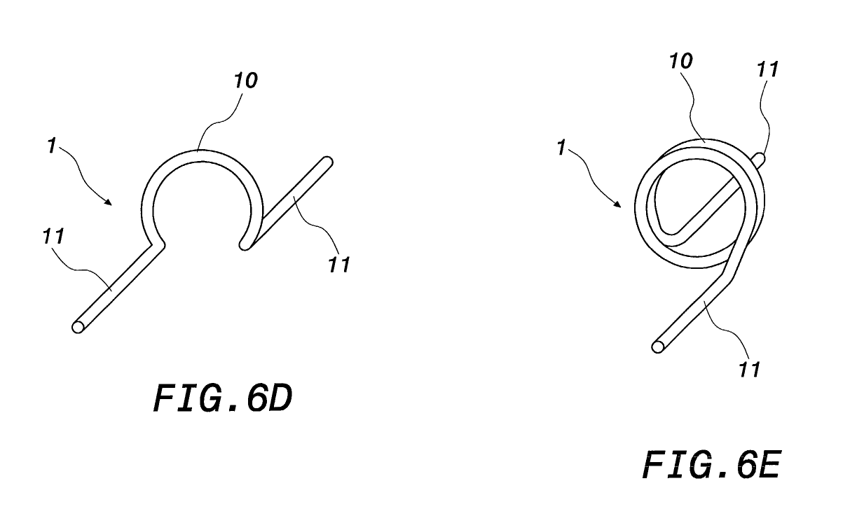

With reference now to FIGS. 6A to 6E, those figures show different preferred embodiment of the present invention.

As shown in FIG. 6A, the clamping structure 1 for foldable apparatus comprises an arc-shaped elastic wire 10 and two linear elastic wires 11. The two linear elastic wires 11 are bent vertically from two ends of the arc-shaped elastic wire 10 and along the axis of the arc-shaped elastic wire 10, and parallel to each other. The distal end of each linear elastic wire 11 is bent vertically downward.

As shown in FIG. 6B, the clamping structure 1 for foldable apparatus comprises an arc-shaped elastic wire 10 with a plurality of turns and two linear elastic wires 11. The two linear elastic wires 11 are bent vertically from two ends of the arc-shaped elastic wire 10 and along the axis of the arc-shaped elastic wire 10, and parallel to each other. The distal end of each linear elastic wire 11 is bent vertically downward.

As shown in FIG. 6C, the clamping structure 1 for foldable apparatus comprises an arc-shaped elastic wire 10 with a plurality of turns and two linear elastic wires 11. The two linear elastic wires 11 are bent vertically from two ends of the arc-shaped elastic wire 10 and along the axis of the arc-shaped elastic wire 10, and parallel to each other.

As shown in FIG. 6D, the clamping structure 1 for foldable apparatus comprises an arc-shaped elastic wire 10 and two linear elastic wires 11. The two linear elastic wires 11 are bent vertically from two ends of the arc-shaped elastic wire 10 and along the axis of the arc-shaped elastic wire 10 in opposite directions, and parallel to each other.

As shown in FIG. 6E, the clamping structure 1 for foldable apparatus comprises an arc-shaped elastic wire 10 with a plurality of turns and two linear elastic wires 11. The two linear elastic wires 11 are bent vertically from two ends of the arc-shaped elastic wire 10 and along the axis of the arc-shaped elastic wire 10 in opposite directions, and parallel to each other.

To sum up, the clamping structure for foldable apparatus can clamp the unfolding angle of a fold-type keyboard firmly and easily.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A clamping structure for foldable apparatus; the foldable apparatus having two separated main bodies connected by a pivotal shaft; the clamping structure comprising
an arc-shaped elastic wire; and
two linear elastic wires bent vertically from two ends of the arc-shaped elastic wire; and pivotally arranged within two rounded holes formed on the two separated main bodies, respectively; each rounded hole having a distance with the pivotal shaft;
the clamping structure providing a torque to the separated main bodies of the foldable apparatus such that the foldable apparatus can be unfolded to 0° and 180°.

2. The clamping structure for foldable apparatus as in claim 1, wherein the foldable apparatus is a fold-type keyboard.

3. The clamping structure for foldable apparatus as in claim 1, wherein the arc-shaped elastic wire is wound a plurality of turns.

4. The clamping structure for foldable apparatus as in claim 1, wherein the two linear elastic wires are bent vertically from two ends of the arc-shaped elastic wire and along the axis of the arc-shaped elastic wire, and parallel to each other.

5. The clamping structure for foldable apparatus as in claim 1, wherein the distal end of each linear elastic wire 11 is bent vertically downward.
